(19) United States
(12) Patent Application Publication
(10) Pub. No.: US 2012/0125058 A1
(43) Pub. Date: May 24, 2012

(54) Disposition Introduced in the Padlock

(75) Inventor: Paolo Papaiz, San Paulo (BR)

(73) Assignee: PAPAIZ NORDESTE INDÚSTRIA E COMÉRCIO LTDA, Salvador (BR)

(21) Appl. No.: 13/300,208

(22) Filed: Nov. 18, 2011

(30) Foreign Application Priority Data
Nov. 23, 2010 (BR) MU9002269-6

(51) Int. Cl. E05B 67/38

(52) U.S. Cl. 70/31

(57) ABSTRACT

In one example, a disposition inserted in the padlock includes two extreme upper and lower parts connected by mobile bracelet or anklet, a central part fixed to the padlock, and a bracelet or anklet for transportation, whereby the upper and lower ends are attachable to each other, when the central part and thereby the padlock are removed from the ends.

### CROSS-REFERENCE TO RELATED APPLICATIONS

This application claims priority to Brazil Patent Application No. MU9002269-6, filed on Nov. 23, 2010, the disclosure of which is herein incorporated herein by reference.

### FIELD OF THE INVENTION

This field relates to improvements in padlock storage systems.

### BACKGROUND OF THE INVENTION

In the current prior art, several dispositions in locks are known.

Currently the locks assist users in many different applications in order to increase security in the sanctity of property.

The small locks allow for use in gyms lockers, schools, and other equipment for temporary confinement of small volumes. Since they are small, they are easy to transport, but they are difficult to keep. There are awkward situations for the use of “key ring” or other elements to store the key.

Normally, due to the small size of the small padlock's key, the user finds it difficult to locate the key, and may even lose the key when they do not want to store it on a “key ring”. This represents a major drawback, because the loss of key results in the need to use a specialized service for its opening, or even its disruption and destruction.

In the state of the art, there are also locks that do not use a key to open, but these types of locks are not relevant for this disclosure.

There remains a continuous need for improved lock systems that avoid misplacing the key.

### SUMMARY OF THE INVENTION

In one example, a disposition inserted in the padlock comprises two extreme upper and lower parts connected by mobile bracelet or anklet, a central part fixed to the padlock, and a bracelet or anklet for transportation, whereby the upper and lower ends are attachable to each other, when the central part and thereby the padlock are removed from the ends.

The central part aims to protect and store the body of the padlock and is fixed to the padlock. The upper and lower ends are intended to protect the padlock rod and the key when the assembly is composed of three parts, i.e., the upper and lower ends over the central part.

When the central part and consequently the padlock is in use or out of the assembly, the upper and lower ends can form a key storage retention capsule and padlock due to the existence of the bracelet or anklet as a link between the upper and lower ends, thereby allowing use of the capsule in the wrist and/or ankle, and thereby providing greater security in key storage.

In another example, a disposition introduced in the padlock, more particularly the small ones, includes a capsule or wrapping that forms when the padlock and (central part) is in use or off the assembly and the extreme top and bottom parts are joined and engaged, involving and storing the key inside it, being connected by a bracelet or anklet, which makes it possible to transport the key fastened to the wrist and/or ankle.

### BRIEF DESCRIPTION OF THE FIGURES

FIG. 1 is a left side view of the padlock of the present invention, with the three parts assembled plus the bracelet or anklet and one cutaway view taken at cut line X-X, showing the disposition of the padlock and key fastened to the model;

FIG. 2 is a left side view with the ends forming a “capsule” and a cutaway view, taken on the Y-Y cut line, revealing the disposition of the key fastened and integrant of the extreme lower part on the model;

FIG. 3 is a perspective view with the central part (padlock plus fastened central part) outside of the assembly;

FIG. 4 is a left side view and a full cutaway view taken from the Z-Z cut line illustrating the rotation movement which unlocks the padlock;

FIG. 5 is a top view illustrating the rotation movement to which unlocks the padlock, according to the disposition shown in FIG. 4;

FIG. 6 is a view that illustrates the use of the central part (the padlock and fastened central part).

FIG. 7 is a left side view of a first alternative constructive disposition, with the three parts assembled plus the bracelet or anklet and a cutaway view taken from the W-W cut line, revealing the disposition of the padlock and not fastened key, being that it is attachable and removable from inside the lower edge part;

FIG. 8 is a left side view with the ends forming a “capsule” and a cutaway view taken at the V-V cut line, showing the disposition of the non-fastened key, as revealed in FIG. 7;

FIG. 9 is a perspective view with the central part (padlock plus fastened central part) outside the assembly and the key not fastened, revealed in FIGS. 7 and 8;

FIG. 10 is a cutaway view of a second constructive alternative, with the disposition of the padlock plus the key not fastened, a left side view taken from the U-U cut line with the three parts assembled and a rear view showing a new mounting location for the bracelet or anklet;

FIG. 11 is a left side view with the ends, revealed in FIG. 10, forming a “capsule” and a cutaway view taken along T-T revealing the disposition of the non-fastened key;

### DETAILED DESCRIPTION OF THE INVENTION

The examples and drawings provided in the detailed description are merely examples, which should not be used to limit the scope of the claims in any claim construction or interpretation.

In one example, a disposition introduced in the padlock, containing three parts of protection to the padlock and a bracelet or anklet for transportation, two extreme mobile parts connected by bracelet or anklet and a central part, which is fixed to the padlock. The center part aims to protect and to store the body of the padlock, fixed to the padlock. The outer edges are intended to protect the shaft and the key, when the assembly is composed of three parts (the extremes plus the central part).

When the padlock (central part) is in use or out of the assembly, the upper and lower ends can interlock, thereby forming a capsule for storage of the padlock key and due to the existence of the bracelet or anklet acting as a link between the ends, it is possible to use the capsule on the wrist and/or ankle, thereby providing greater security in key storage.

Alternative constructive dispositions are disclosed, and the key can be attached to the far lower part or also embedded and can be removed.

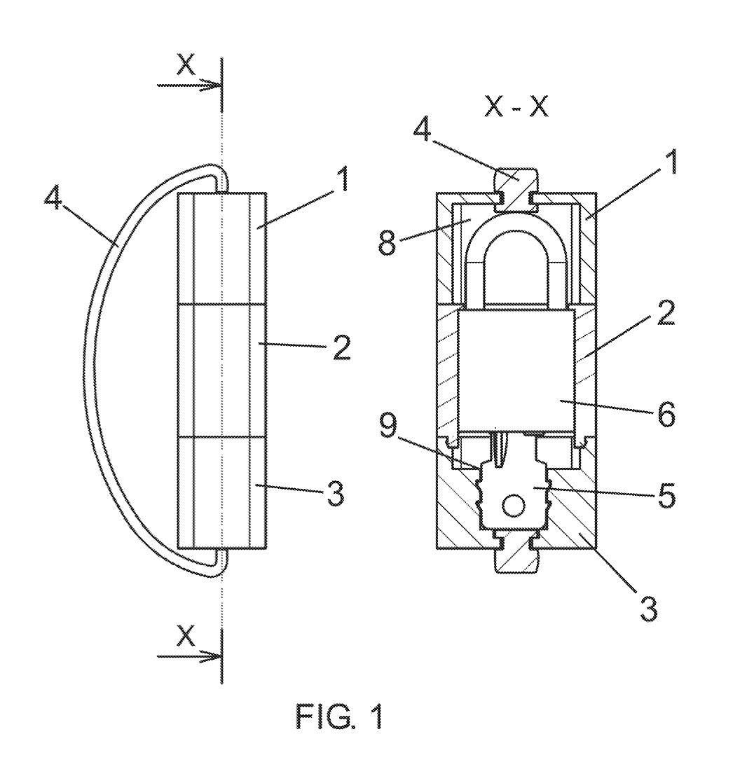

According to FIG. 1, a padlock disposition consists of an upper end (1) with a hollow interior chamber (8), and the said upper end (1) is attachable to the central part (2) which contains a body of the padlock (6) fixed inside the central part.

The said central part (2) is attachable to both the upper end (1) and to the lower end (3), configuring an attachable set.

The chamber (8) accommodates the padlock body (6) in its interior, with the said central part (2) coupled to the upper end (1). The padlock may be a rod, for example.

The lower end (3) is provided with a cavity (9) that holds the key (5), which is fastened and is not removable from the lower end (3) in this embodiment.

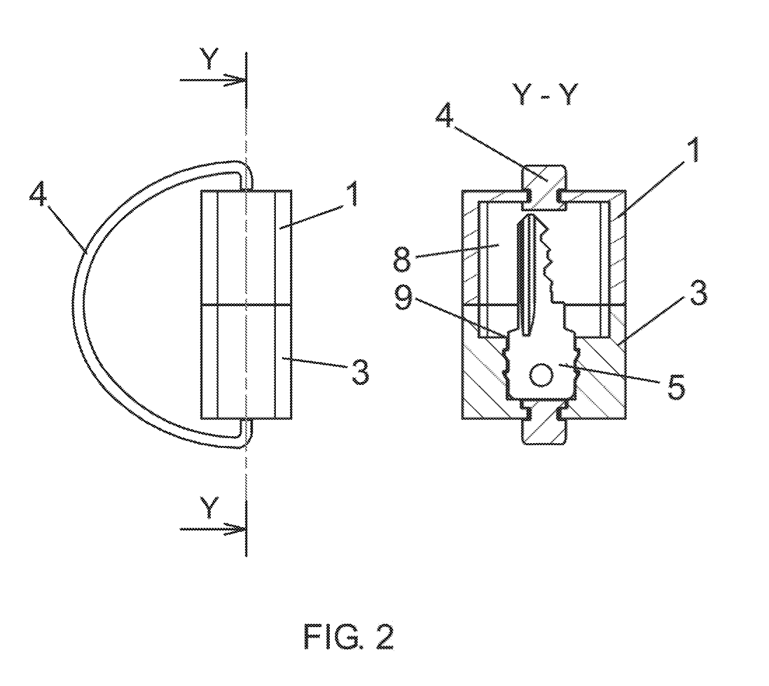

As shown in FIG. 2, once the central part (2) is removed and consequently the padlock (6) connected to it is removed, the upper end (1) and lower end (3) are attachable to each other, setting forth a retention capsule, thereby allowing for protection of the key (5) inside, and from the ends (1,3), an apparatus which may be bracelet or an anklet (4) or a combination forms, thereby joining the upper and lower ends (1,3), and is adjustable to the user's wrist and/or ankle, and is of various sizes. Thus a bracelet or anklet (4) may be used to carry a retention capsule holding a key (5).

Thus, the use of the ends (1,3) attachable to the central part (2) allows the accommodation of the key (5) and padlock (6) inside in the retention capsule.

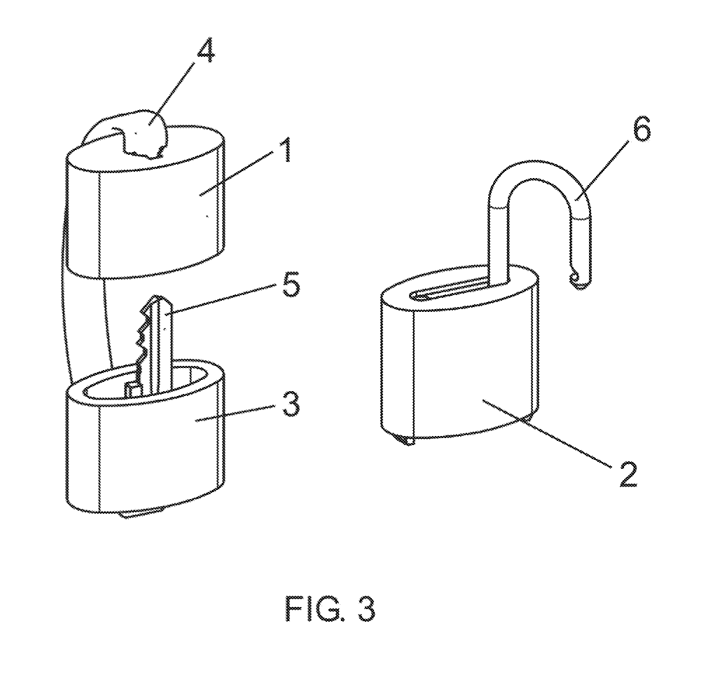

FIG. 3 is a perspective view with the central part (2) disengaged from the upper and lower ends (1,3).

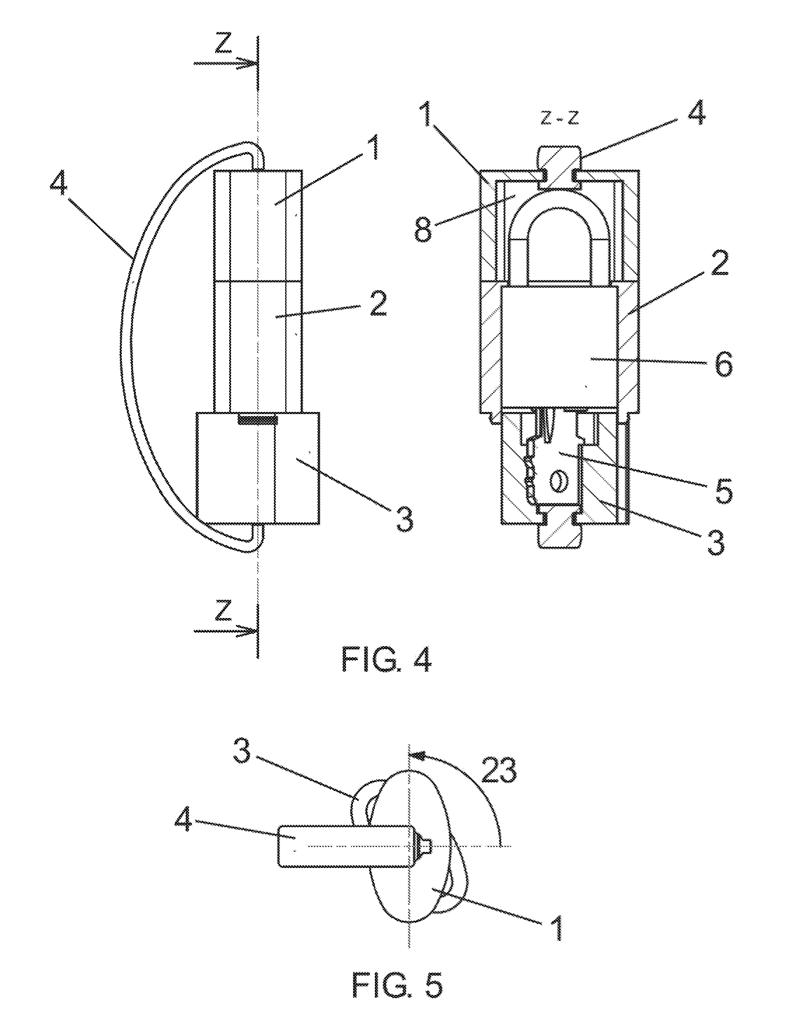

As shown in FIGS. 4 and 5, the coupling system between the central part (2) and lower end (3) allows the rotation of the lower end (3) in relation to the central part (2), promoting the unlocking of the padlock (6), since key (5) activates its unlocking.

To use a free padlock (6), disengage the upper end (1) from the central part (2) and in turn disengage the lower end (3) from the central part (2), such that the central part is thereby disengaged (2) and the padlock (6) is thus unlocked. For example, the lower end (3) may be rotated or spinned (23) to be disengaged from the central part.

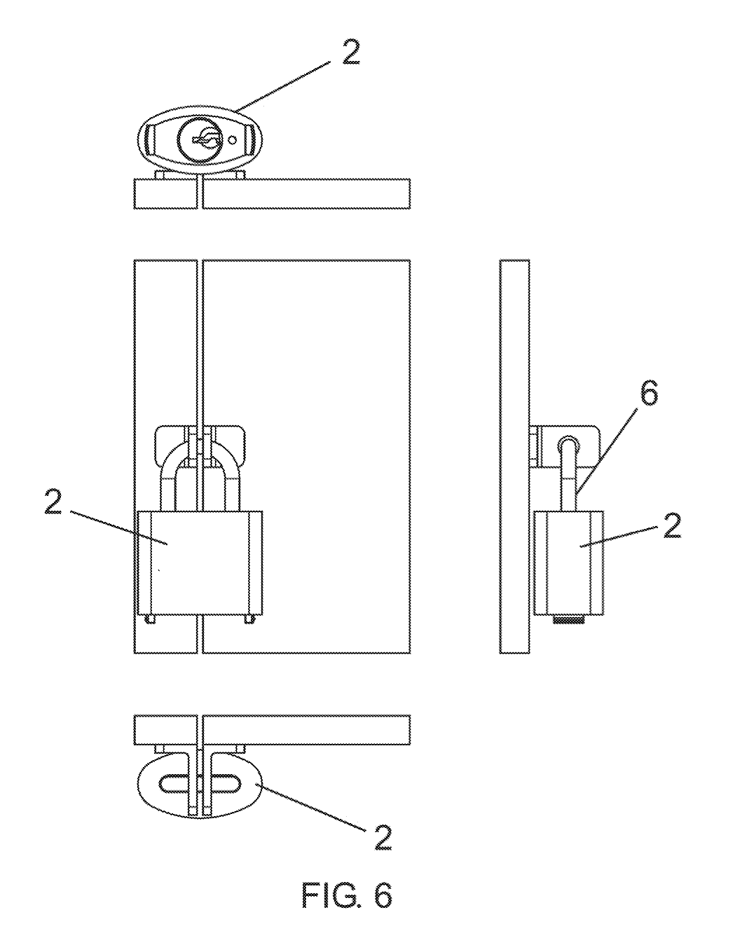

With the central part (2) disengaged and the padlock (6) unlocked, its use is allowable. FIG. 6 is a view that illustrates the use of the central part (2) and the padlock (6) integrated to it.

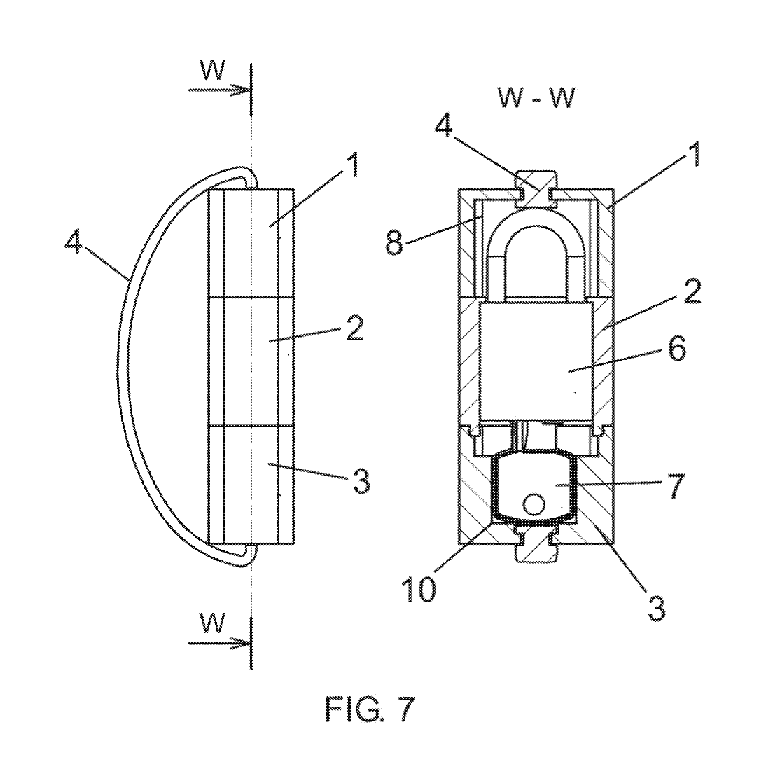

According to FIGS. 7 to 9, an alternative constructive disposition includes an upper end (1), with hollow interior chamber (8), and the mentioned upper end (1) is attachable to the central part (2) which has the body of the padlock fastened inside.

The mentioned central part (2) is attachable both to the upper end (1) and the lower end (3), configuring an attachable set.

The chamber (8) accommodates the padlock body (6) in its interior, and the mentioned central part 2 is coupled to the upper end (1). The padlock body may be a rod, for example.

The lower end (3) is provided with a cavity (10) that holds the key (7), which is attachable and removable from the lower end (3).

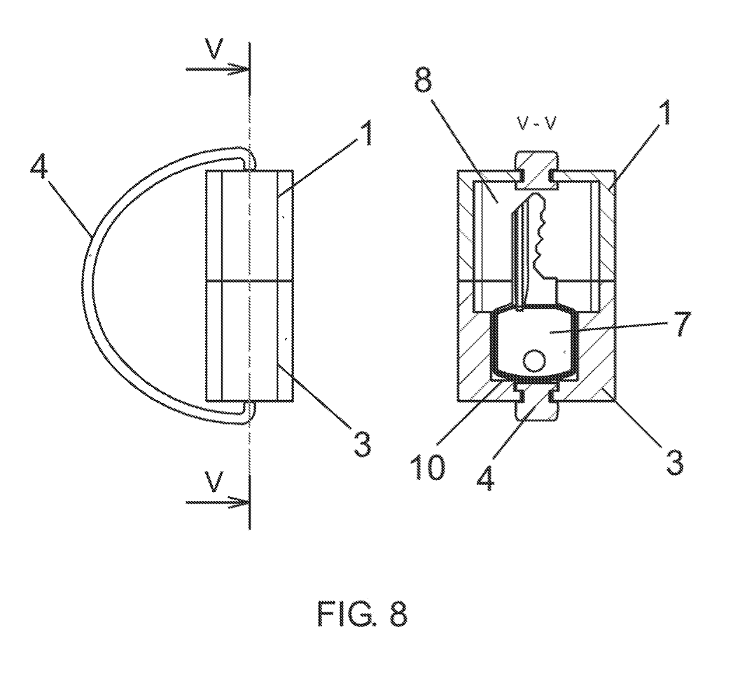

As shown in FIG. 8, once the central part (2) is removed and consequently the padlock (6) connected to it, the upper end (1) and the lower end (3) are attachable to each other, configuring a retention capsule, thereby allowing for protection of key (7) inside, and from the upper and lower ends (1,3) comes out a bracelet or anklet (4) or a combination forms, which joins the mentioned ends (1,3), and is adjustable to the user's wrist and/or ankle, and has various sizes.

Thus, the use of the ends (1,3) attachable to the central part (2) allows for the accommodation of the removable key (7) and padlock (6) inside in the retention capsule.

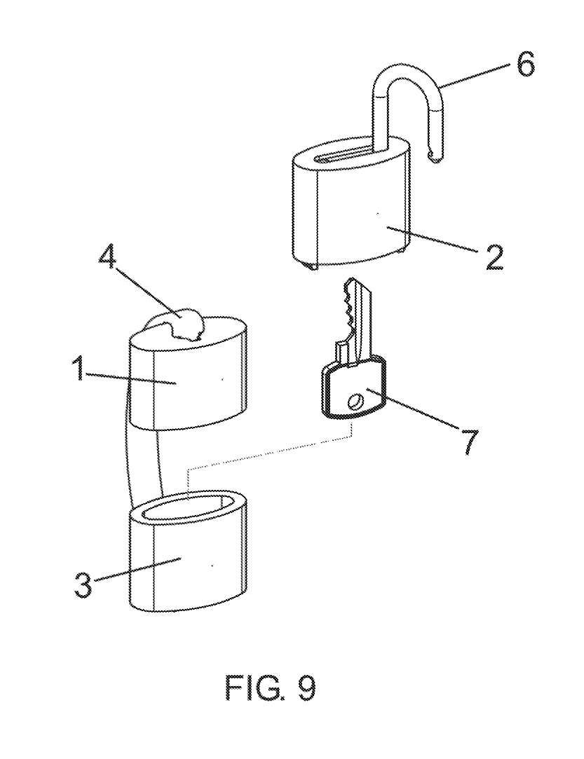

FIG. 9 is a perspective view with the central part (2) and key (7) disengaged from the ends (1,3).

The coupling system between the central part (2) and lower end (3) allows the rotation of the mentioned lower end (3) in the central part (2), promoting the unlocking of the padlock (6), since the key (7) activates the padlock's unlocking, where the key is being housed inside the cavity (10).

To use a free padlock (6), disengage the upper end (1) from the central part (2) and in turn disengage the lower end (3) from the central part (2) such that the central part (2) is disengaged and the padlock rod (6) is unlocked, while allowing the non-fastened key (7) which does not remain lodged in the padlock (6). Thus, when the central part (2) is disengaged and the padlock (6) unlocked, the padlock's use is possible.

For storage of the key (7) not fastened to the retention capsule, the key is removed from the padlock (6) and is installed in the cavity (10) of the lower end (3).

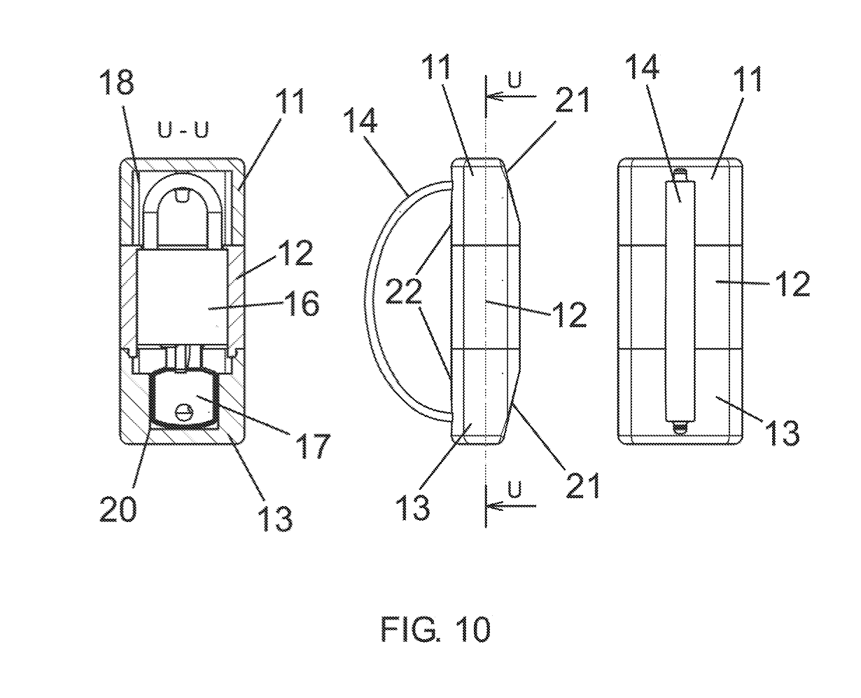

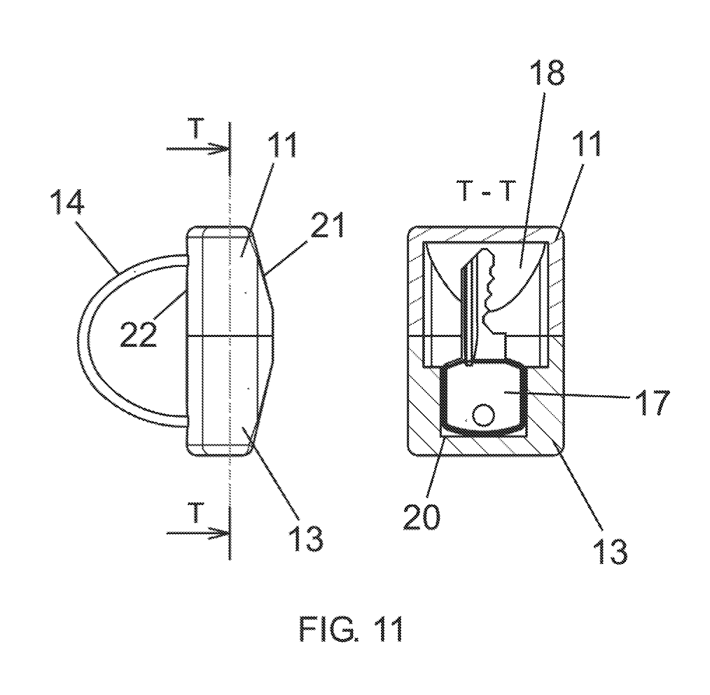

According to FIGS. 10 and 11, an alternative constructive disposition comprises an upper end (11), with hollow interior chamber (18), and the mentioned upper end (11) is attachable to the central part (12) containing a body of the padlock (16) fastened inside. The padlock (16) may be a rod, for example.

The mentioned central part (12) is attachable to both the upper end (11) and the lower end (13), configuring an attachable set.

The front part of the ends (11,13) is provided with ergonomic notches (21) which extend to the vicinity of a contact area with the central part (12).

The chamber (18) accommodates the padlock (16) inside, with the mentioned central part (2) being coupled to the upper end (11).

The lower end (13) is provided with a cavity (20) that holds the key (17), which is attachable and removable from the lower end (13).

As shown in FIG. 11, once the central part (12), and consequently the padlock (16) connected to it is removed, the upper end (11) and the lower end (13) are attachable to each other, configuring a retention capsule and protection of the key (17) inside, and from a respective rear face (22) of the ends (11,13) protrudes a bracelet or anklet (14) joining the mentioned ends (11,13), and is adjustable to the user's wrist and/or ankle and has various sizes.

Thus, the use of ends (11,13) attachable to the central part (12) allows the accommodation of the removable key (17) and the padlock (16) inside a retention capsule.

The coupling system between the central part (12) and lower end (13) allows for the rotation of the mentioned lower end (13) in the central part (12), promoting the unlocking of the padlock (16), since the key (17) activates the padlock's unlocking, where the key being housed inside the cavity (20).

To use the padlock (16) disengage the upper end (11) from the central part (12) and in turn disengage the lower end (13) from the central part (12), such that the central part (12) is disengaged and the padlock (16) unlocked, while allowing the non-fastened key (17) to remain housed in the padlock (16).

When the central part (12) is disengaged and the padlock (16) is unlocked, the use of the padlock is possible.

To store the unfastened key (17) in the retention capsule, the key is removed from the padlock (16) and the key is installed in the cavity (20) of the lower end (13).

One advantage of the disposition refers to the fact that the existence of the capsule allows for easy storage of the key, making it harder to lose.

Moreover, the existence of a bracelet or anklet allows the user to always have the key to the padlock with them during their activities, in a safe and practical manner.

Furthermore, the capsule represents a safe and ergonomic casing to keep the key inside.

The following is a list of reference numerals and associated parts as used in this specification and drawings:

| Reference Numeral | Part |
|---|---|
| 1 | Upper end |
| 2 | Central Part |
| 3 | Lower end |
| 4 | Anklet or Bracelet or Combination |
| 5 | Key |
| 6 | Padlock |
| 7 | Key |
| 8 | Chamber |
| 9 | Cavity |
| 10 | Cavity |
| 11 | Upper end |
| 12 | Central Part |
| 13 | Lower end |
| 14 | Anklet or Bracelet or Combination |
| 16 | Padlock |
| 17 | Key |
| 18 | Chamber |
| 20 | Cavity |
| 21 | Notches |
| 22 | Rear Face |
| 23 | Spin |

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A disposition introduced in a padlock, comprising:
an upper end with an interior chamber;
a central part attachable to the upper end and a lower end, configuring an attachable set, wherein the central part includes the padlock fastened inside said central part;
wherein the chamber accommodates the padlock being positioned inside the chamber;
wherein the lower end includes a cavity for accommodating a key, the key being fastened and not readily removable from the lower end; and
wherein when the central part is removed, and consequently the padlock being connected to the central part is removed, 1) the upper end and the lower end are attachable to each other, allowing for a retention capsule, thereby allowing for protection of the key inside, and 2) from the upper and lower ends, protrudes a bracelet or anklet joining the ends, the bracelet or ankle being adjustable to a user's wrist or ankle or both and has various sizes; and
wherein a coupling system between the central part and the lower end allows for rotation of the lower end in relation to the central part, allowing for promotion of an unlocking of the padlock, as the key activates the unlocking of the padlock, wherein the padlock is usable when the upper end is disengaged from the central part, and the lower end is disengaged from the central part, such that the central part is disengaged and the padlock is thereby unlocked.

2. The disposition according to claim 1, wherein the lower end further comprises a cavity that holds the key;
the upper end is attachable to the central part, the central part includes the padlock being fixed inside the central part; the central part being attachable to both the upper end and the lower end, forming an attachable set; wherein the chamber also accommodates the padlock in its interior, the central part being coupled to the upper end and the lower end; and wherein the key is attachable and removable from the lower end;
wherein when the upper and lower ends are removed from the central part, and consequently the padlock connected to the central part, the upper end and lower end are attachable to each, other, forming the retention capsule and protection of the key and from the upper and lower ends, a bracelet or ankle or a combination forms, and joins the upper and the lower ends, and is adjustable to the user's wrist or ankle or both and has various sizes;
wherein the coupling system between the central part and the lower end allows for the rotation of the lower end in the central part promoting the disengagement of the padlock since the key activates the unlocking of the padlock, the key being housed in the padlock; and
wherein the padlock is usable when the upper end is disengaged from the central part, and the lower end is rotated such that the lower end is disengaged from the central part, and the padlock is unlocked, while allowing the key not to remain in the padlock, wherein the key is not attached to the retention capsule, the key thereby being removed from the padlock and installed in the cavity of the lower end.

3. The disposition according to claim 1, wherein the lower end further comprises a cavity that holds the key, the upper and lower ends each respectively further comprises a front portion that includes ergonomic notches which extend into a vicinity of contact with the central part, the upper and lower ends each respectively further comprises a rear portion;
the upper end being attachable to the central part, the central part containing a body of the padlock being fixed inside, the central part is attachable to both the upper end and the lower end, configuring an attachable set; the chamber accommodating the padlock inside; the lower end being provided with the cavity that holds the key which is attachable and removable from the lower end,
once the upper and lower ends are removed from the central part and consequently the padlock connected to the central part, the upper end and the lower end are attachable to each other, setting forth the retention capsule and protection of the key inside, such that from the rear portions of the upper and lower ends, a bracelet or ankle or a combination forms, and joins the upper and the lower ends, and is adjustable to the users wrist or ankle or both and has various sizes;
wherein the coupling system between the central part and the lower end allows for the rotation of the lower end in the central part, promoting the disengagement of the padlock, since the key drives the unlocking of the padlock, wherein the key is housed in the cavity; and
wherein the padlock is usable when the upper end is disengaged from the central part, and in turn the lower end is disengaged from the central part, the padlock is thereby unlocked, while allowing the key not to remain in the padlock, wherein the key is not attached to the retention capsule and the key thereby being removed from the padlock and installed in the cavity of the lower end.
